(19) United States
(12) Patent Application Publication
(10) Pub. No.: US 2015/0056115 A1
(43) Pub. Date: Feb. 26, 2015

(54) COMPOUND INCLUDING ACTIVATED METAL AND LIGAND, CARBON DIOXIDE ABSORBENT INCLUDING THE COMPOUND, METHOD OF PREPARING THE CARBON DIOXIDE ABSORBENT, AND METHOD OF REMOVING CARBON DIOXIDE

(71) Applicant: KOREA INSTITUTE OF ENERGY RESEARCH, Daejeon (KR)

(72) Inventors: Soon Kwan Jeong, Daejeon (KR); Yeo Il Yoon, Daejeon (KR); Sung Chan Nam, Daejeon (KR); Soo Hyun Chol, Daejeon (KR); Sung Ho Yoon, Seoul (KR); Dong Kook Park, Seoul (KR)

(73) Assignee: KOREA INSTITUTE OF ENERGY RESEARCH, Daejeon (KR)

(21) Appl. No.: 14/293,001

(22) Filed: Jun. 2, 2014

(30) Foreign Application Priority Data
Aug. 21, 2013 (KR) 10-2013-0098974

(51) Int. Cl. B01J 31/22; B01D 53/86

(52) U.S. Cl. CPC B01J 31/2295; B01D 53/8671
USPC 423/228; 548/106; 546/6

(57) ABSTRACT

Provided is a compound including an activated metal and a ligand, a carbon dioxide (CO₂) absorbent including the compound, a method of preparing the CO₂ absorbent, and a method of removing CO₂.

### CROSS-REFERENCE TO RELATED APPLICATION

This application claims the benefit of Korean Patent Application No. 10-2013-0098974, filed on Aug. 21, 2013, in the Korean Intellectual Property Office, the disclosure of which is incorporated herein by reference.

### TECHNICAL FIELD OF THE INVENTION

The present invention relates to a compound including an activated metal and a ligand, a carbon dioxide (CO₂) absorbent including the compound, a method of preparing the CO₂ absorbent, and a method of removing CO₂.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

According to the International Energy Agency (IEA), use of carbon dioxide capture and storage (CCS) as a countermeasure against global warming is expected to contribute to about a 19% reduction in global carbon dioxide (CO₂) emissions. In order to proliferate a supply of the CCS, technology assessment and economic feasibility secure may be required. Based on the current level of technology, the IEA estimates costs for CCS at USD 68 to 121/ton carbon dioxide (tCO₂) [“Cost and Performance of Carbon Dioxide Capture from Power Generation”, IEA, 2011; and “Report of the Interagency Task Force on Carbon Capture and Storage”, CSLF, 2010]. Since such costs may give rise to increased production costs for development and commercialization, research and development is being conducted on reducing expenses for installation and operation of the CCS. A greatest portion of costs for the CCS is used to capture CO₂, and most of the CO₂ capturing costs may be used for regeneration energy to be used to separate CO₂ from an absorbent capturing CO₂. Thus, current research on a CO₂ capture process focuses on development of an absorbent material capable of reducing an amount of regeneration energy to be used. Although a reduction in an amount of regeneration energy to be used may be most significant in developing the CO₂ capture process in terms of cost reduction, reduction in a size of an absorption tower through an increase in a CO₂ absorption rate may also be required.

Atmospheric CO₂ dissolves quickly in water to form hydrated CO₂, as expressed by Reaction Formula 1. CO₂(aq.) reacts with water to form carbonic acid, as expressed by Reaction Formula 2, or reacts with a hydroxide ion at high pH to form bicarbonate. At pH<8, a hydroxide ion does not exist and thus, Reaction Formula 4 may be ignored. At 8<pH<10, Reaction Formulae 2 through 4 occur simultaneously. At pH>10, Reaction Formula 4 is dominant. A bicarbonate salt ion is converted quickly to a carbonate ion, as expressed by Reaction Formula 5. When a pertinent cation exists, the converted carbonate ion is easily precipitated at standard temperature and pressure as a carbonate material, for example, calcium carbonate (CaCO₃), and magnesium carbonate (MgCO₃). Since the carbonate material is a material capable of storing CO₂ most stably on earth and usable for paper, construction resources, and industries, a portion of expenses to be used to capture and store CO₂ may be offset.

CO₂(g) [symbol] CO₂(aq.) [Reaction Formula 1]

CO₂(aq.)+H₂O [symbol] H₂CO₃ [Reaction Formula 2]

H₂CO₃ [symbol] H⁺+HCO₃⁻CO₃ [Reaction Formula 3]

CO₂(aq.)+OH⁻ [symbol] HCO₃⁻ [Reaction Formula 4]

HCO₃⁻ [symbol] H⁺+CO₃²⁻ [Reaction Formula 5]

Ca²⁺+CO₃²⁻ [symbol] CaCO₃ [Reaction Formula 6]

Among the foregoing reaction formulae, a reaction formula to be applied to a rate determining step corresponds to Reaction Formula 2 of which a forward reaction constant corresponds to merely about 6.2×10⁻²s⁻¹ (25° C.). Thus, a reaction medium capable of creating carbonic acid by accelerating or omitting formation of carbonic acid may be required. A carbonic anhydrase existing in nature is known as an optimal enzyme to perform such a role. The carbonic anhydrase is a type of metalloenzyme including zinc. The carbonic anhydrase is involved in CO₂ intake and liberation in a red blood cell during respiration, and generation and secretion of a hydrogen ion and a bicarbonate ion in various secretory organs. The carbonic anhydrase is known as existing in osseous tissues as well [T. H. Maren, Physiol. Res. 47, 595-781 (1967)].

Among carbonic anhydrases, HCA II existing in a human body is known as an enzyme that catalyzes a quickest reaction on earth. HCA II hydrates at least 1.4×10⁶ CO₂ molecules per second. When a carbonic anhydrase exists during a CO₂ absorption reaction, bicarbonate is generated in a state in which the rate determining step of Reaction Formula 2 is omitted, whereby the overall reaction rate increases. Thus, when HCA II is applied to a CO₂ capturing reaction, HCA II may increase a CO₂ absorption rate. HCA II exhibits a CO₂ absorption rate about 100 times higher than monoethanolamine (MEA) with a relatively high CO₂ absorption rate, among amine absorbents [Carbozyme Inc. GHGT-9 (2008)].

However, in a case in which a carbonic anhydrase is applied to a CO₂ capture process to remove CO₂ emitted when fossil fuel combusts, a rapid deactivation may result from an unfolding phenomenon of enzyme protein at temperature over 50° C. Due to a sensitivity to a change in pH, use of the carbonic anhydrase in a commercialized process may be difficult. In addition, the carbonic anhydrase is obtainable from various extraction sources, for example, a human body, and a bovine serum. However, a process of extracting and refining a carbonic anhydrase is difficult and expensive. Thus, when a carbonic anhydrase is prepared through chemical copying (mimicking), effects of temperature and pH may be prevented and unit costs may be reduced by mass production.

FIG. 1 illustrates an active site of a carbonic anhydrase. Referring to FIG. 1, the carbonic anhydrase is in a form in which a zinc ion acts as an active site at the center and three histidine amino acids are combined in a vicinity of the zinc ion, in particular, a form in which three nitrogen ions are combined in a vicinity of the active site. However, a zinc ion has an essential property of being combined with at least four ligands. Thus, as shown in FIG. 2, a mimetic catalyst of a carbonic anhydrase according to a related art was prepared using a ligand including four nitrogens and exhibited a relatively low CO₂ absorption activity [L. Koziol et. al., Inorganic Chemistry, 2012, 51, 6803-6812]. Due to a dimerization of a mimetic catalyst prepared using three ligands containing nitrogen, the mimetic catalyst exhibited a relatively low CO₂ absorption activity, when compared to a mimetic catalyst prepared using four ligands containing nitrogen [Acc. Chem. Res., 34, 171-179 (2001)].

### SUMMARY OF THE INVENTION

An aspect of the present invention provides a compound that may replace an absorbent used for an existing carbon dioxide (CO₂) absorption process, decrease a size of a CO₂ absorption tower, and reduce an operation expense, a CO₂ absorbent including the compound, a method of preparing the CO₂ absorbent, and a method of removing CO₂.

The present invention is not limited to the above purposes and other purposes not described herein will be apparent to those skilled in the art from the following description.

According to a first aspect of the present invention, there is provided a compound including an activated metal, and a ligand.

The activated metal may include zinc.

The ligand may include at least one of Tris(hydroxyl-1-benzimidazolylmethyl)amine, Tris(nitro-2-benzimidazolylmethyl)amine, 2,2-(methoxy(6-methoxypyridin-2-yl)methylene)dipyridine, and Tris(2-(6-methoxy)pyridyl)methanol.

The compound may be represented by Formula 1,

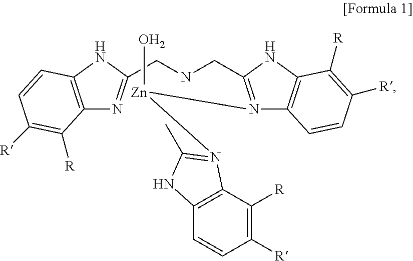

wherein R and R′ independently correspond to one of hydrogen (H), hydroxide (OH), nitrogen dioxide (NO₂), and sulphonic acid (SO₃H).

The compound may be represented by Formula 2,

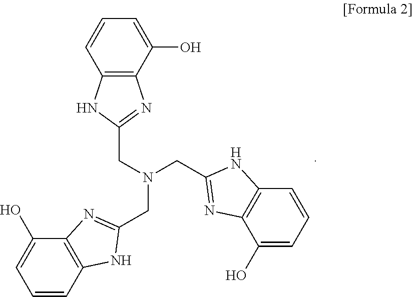 [SMILES: Oc1cccc2[nH]c(CN(Cc3nc4c(O)cccc4[nH]3)Cc3nc4c(O)cccc4[nH]3)nc12]

The compound may be represented by Formula 3,

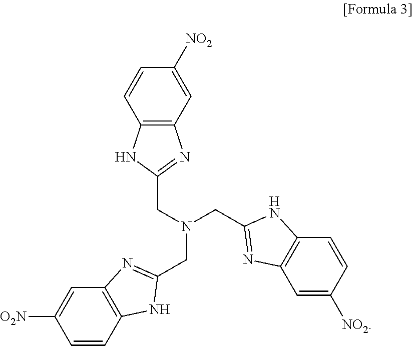 [SMILES: O=[N+]([O-])c1ccc2[nH]c(CN(Cc3nc4cc([N+](=O)[O-])ccc4[nH]3)Cc3nc4cc([N+](=O)[O-])ccc4[nH]3)nc2c1]

The compound may be represented by Formula 4,

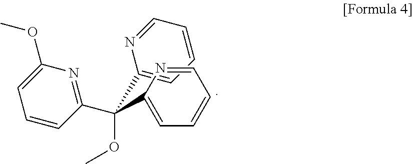

The compound may be represented by Formula 5,

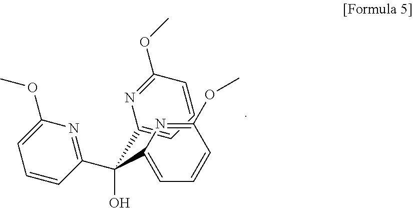

The activated metal may range from 10 weight % (wt %) to 35 wt % of the compound, and the ligand may range from 65 wt % to 90 wt % of the compound.

According to a second aspect of the present invention, there is provided a CO₂ absorbent including the compound according to the first aspect of the present invention.

According to a third aspect of the present invention, there is provided a method of preparing a CO₂ absorbent, the method including preparing a compound including an activated metal and a ligand.

The activated metal may include zinc.

The ligand may include at least one of Tris(hydroxyl-1-benzimidazolylmethyl)amine, Tris(nitro-2-benzimidazolylmethyl)amine, 2,2-(methoxy(6-methoxypyridin-2-yl)methylene)dipyridine, and Tris(2-(6-methoxy)pyridyl)methanol.

The activated metal may range from 10 wt % to 35 wt % of the compound, and the ligand may range from 65 wt % to 90 wt % of the compound.

According to a fourth aspect of the present invention, there is provided a method of removing CO₂, the method including contacting gas containing CO₂ with a CO₂ absorbent including a compound including an activated metal and a ligand, absorbing CO₂ from the gas, and regenerating the CO₂ absorbent.

The absorbing may be performed in the pressure range between atmospheric pressure and 10 atmospheres (atm) and the temperature range between room temperature and 70° C.

The regenerating may be performed in the pressure range between 0.01 and 5 atm and the temperature range between 80° C. and 150° C.

The compound including the activated metal and the ligand may be dissolved in water or a CO₂ absorbent, or may include nanoparticles. The compound including the activated metal and the ligand may circulate.

The CO₂ absorbent may further include at least one of a tertiary amine, potassium carbonate (K₂CO₃), lithium carbonate (Li₂CO₃), sodium carbonate (Na₂CO₃), and rubidium carbonate (Rb₂CO₃).

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an active site of a carbonic anhydrase;

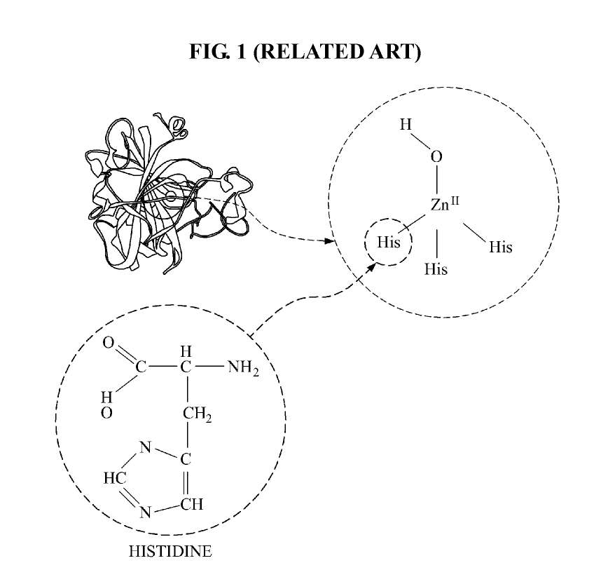

FIG. 2 illustrates a mimetic catalyst of a carbonic anhydrase;

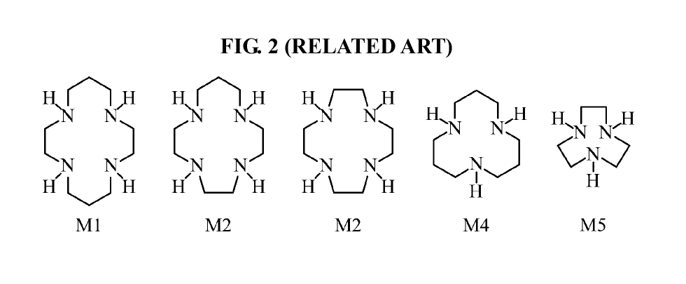

FIG. 3 illustrates a method of preparing a carbon dioxide (CO₂) absorbent according to an embodiment of the present invention;

FIG. 4 illustrates a method of removing CO₂ according to an embodiment of the present invention; and

FIG. 5 is a graph illustrating a comparison of a CO₂ absorption capacity of a CO₂ absorbent according to an embodiment of the present invention to that of a CO₂ absorbent according to a related art.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the another element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Hereinafter, a compound, a carbon dioxide (CO₂) absorbent including the compound, a method of preparing the CO₂ absorbent, and a method of removing CO₂ will be described in detail with reference to the accompanying drawings and exemplary embodiments. However, the present invention is not limited to the drawings and exemplary embodiments.

A compound according to a first aspect of the present invention may include an activated metal and a ligand.

The activated metal may include zinc.

The ligand may include at least one of Tris(hydroxyl-1-benzimidazolylmethyl)amine, Tris(nitro-2-benzimidazolylmethyl)amine, 2,2-(methoxy(6-methoxypyridin-2-yl)methylene)dipyridine, and Tris(2-(6-methoxy)pyridyl)methanol.

In an example, the compound may be represented by Formula 1.

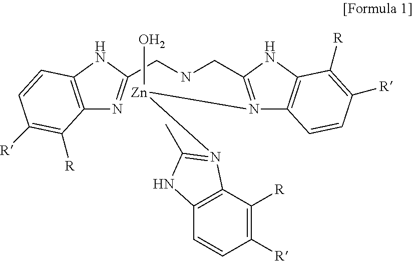

In Formula 1, R and R′ may independently correspond to one of hydrogen (H), hydroxide (OH), nitrogen dioxide (NO₂), and sulphonic acid (SO₃H).

The compound may correspond to a mimetic catalyst of a carbonic anhydrase, which is most similar to a natural carbonic anhydrase, in which a zinc ion acts as an active site at the center, three ligands containing nitrogen are combined, and a ligand capable of dissociating a hydrogen ion from a watermolecule to be combined with the zinc ion is combined to promote an activity. In addition, the compound may induce a steric hindrance of a ligand to be combined and thus, may prevent a dimerization of a mimetic catalyst according to a related art although the mimetic catalyst is prepared using a ligand containing three nitrogens.

In Formula 1, a ligand containing four nitrogens is present in a periphery of a zinc ion corresponding to an activated metal. However, three nitrogen groups are combined with the zinc ion in a form similar to a natural carbonic anhydrase. In a basic structure similar to Formula 1, R and R′ may independently be replaced with one of H, OH, NO₂, and SO₃H in terms of electron transfer. A steric hindrance may also be considered to prevent an occurrence of a dimerization.

Such a mimetic catalyst of a carbonic anhydrase has a CO₂ absorption reaction rate similar to that of the natural carbonic anhydrase, and an activity unchanged at temperature below 200° C. and at pH ranging from 5 to 11.

In another example, the compound may be represented by Formula 2.

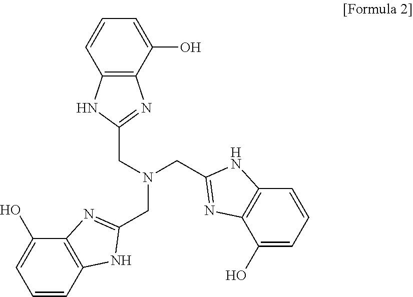 [SMILES: Oc1cccc2[nH]c(CN(Cc3nc4c(O)cccc4[nH]3)Cc3nc4c(O)cccc4[nH]3)nc12]

The compound represented by Formula 2 corresponds to a combination of OH and the compound represented by Formula 1.

In still another example, the compound may be represented by Formula 3.

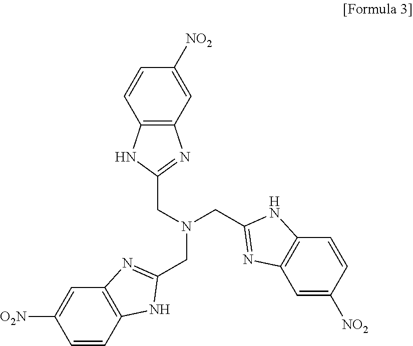 [SMILES: O=[N+]([O-])c1ccc2[nH]c(CN(Cc3nc4cc([N+](=O)[O-])ccc4[nH]3)Cc3nc4cc([N+](=O)[O-])ccc4[nH]3)nc2c1]

The compound represented by Formula 3 corresponds to a combination of NO₂ and the compound represented by Formula 1.

In yet another example, the compound may be represented by Formula 4.

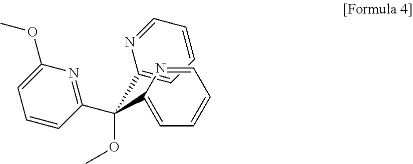

In further another example, the compound may be represented by Formula 5.

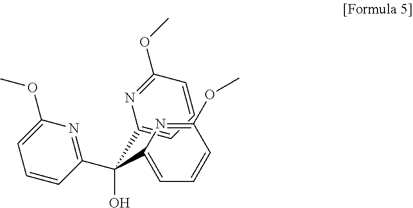

The activated metal may range from 10 weight % (wt %) to 35 wt % of the compound. When the activated metal is less than 10 wt % of the compound, the structure thereof as the mimetic catalyst may be excessively complex and thus, production costs of the catalyst may increase greatly. When the activated metal is greater than 35 wt % of the compound, a dimerization may occur.

The ligand may range from 65 wt % to 90 wt % of the compound.

A CO₂ absorbent according to a second aspect of the present invention may include the compound according to the first aspect of the present invention.

The CO₂ absorbent may include a corrosion inhibitor, a coagulant aid, an oxygen inhibitor, an antifoaming agent, and a mixture thereof.

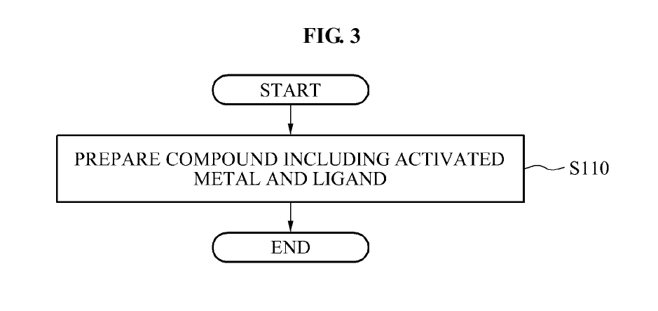

FIG. 3 illustrates a method of preparing a CO₂ absorbent according to an embodiment of the present invention. Referring to FIG. 3, the method of preparing a CO₂ absorbent according to a third aspect of the present invention may include operation 5110 of preparing a compound including an activated metal and a ligand.

In operation 5110, a compound including a divalent metal ion and a ligand may be prepared.

The activated metal may include zinc.

The activated metal may range from 10 wt % to 35 wt % of the compound. When the divalent metal ion is less than 10 wt % of the compound, the structure thereof as the mimetic catalyst may be excessively complex and thus, production costs of the catalyst may increase greatly. When the divalent metal ion is greater than 35 wt % of the compound, a dimerization may occur.

The ligand may include at least one of Tris(hydroxyl-1-benzimidazolylmethyl)amine, Tris(nitro-2-benzimidazolylmethyl)amine, 2,2-(methoxy(6-methoxypyridin-2-yl)methylene)dipyridine, and Tris(2-(6-methoxy)pyridyl)methanol.

The ligand may range from 65 wt % to 90 wt % of the compound.

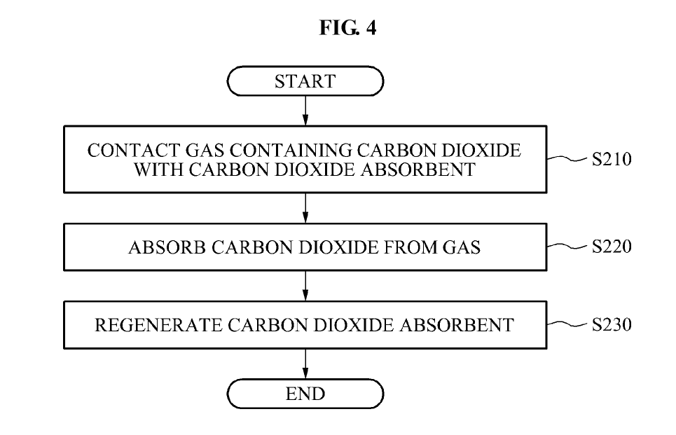

FIG. 4 illustrates a method of removing CO₂ according to an embodiment of the present invention. Referring to FIG. 4, the method of removing CO₂ according to a fourth aspect of the present invention may include operation 5210 of contacting gas containing CO₂ with a CO₂ absorbent including a compound including an activated metal and a ligand, operation 5220 of absorbing CO₂ from the gas, and operation 5230 of regenerating the CO₂ absorbent.

In operation 5210, gas containing CO₂ may be contacted with a CO₂ absorbent including a compound including an activated metal and a ligand.

The activated metal may include zinc.

The ligand may include at least one of Tris(hydroxyl-1-benzimidazolylmethyl)amine, Tris(nitro-2-benzimidazolylmethyl)amine, 2,2-(methoxy(6-methoxypyridin-2-yl)methylene)dipyridine, and Tris(2-(6-methoxy)pyridyl)methanol.

In operation S220, CO₂ may be absorbed from the gas.

Operation 5220 may be performed in the pressure range between atmospheric pressure and 10 atmospheres (atm), preferably between 2 atm and 10 atm, and the temperature range between room temperature and 70° C., preferably between 40° C. and 70° C.

In general, a CO₂ absorption rate increases as temperature decreases and as pressure increases. However, when outside the temperature range and the pressure range mentioned above, costs for performing the process may increase excessively and thus, an efficiency of the absorption process may decrease. Accordingly, the CO₂ absorption process may need to be performed within the temperature range and the pressure range.

The CO₂ absorbent may further include at least one of a tertiary amine, potassium carbonate (K₂CO₃), lithium carbonate (Li₂CO₃), sodium carbonate (Na₂CO₃), and rubidium carbonate (Rb₂CO₃). The compound including the activated metal and the ligand may be solely used as the CO₂ absorbent. In addition, the compound including the activated metal and the ligand may be used as a role that increases CO₂ absorption rates of a tertiary amine, K₂CO₃, Li₂CO₃, Na₂CO₃, and Rb₂CO₃ in the CO₂ absorption process using the tertiary amine, K₂CO₃, Li₂CO₃, Na₂CO₃, and Rb₂CO₃.

In operation 5230, the CO₂ absorbent may be regenerated.

Operation 5230 may be performed in the pressure range between 0.01 and 5 atm, preferably between atmospheric pressure and 2 atm, and the temperature range between 80° C. and 150° C., preferable between 90° C. and 120° C., more preferably between 105° C. and 120° C.

In operation S210, the compound including the activated metal and the ligand may be dissolved in water or a CO₂ absorbent or include nanoparticles, and circulate along with water or the CO₂ absorbent between operation 5220 and operation 5230. In operation 5220, CO₂ absorption may be catalyzed. In operation 5230, an amount of regeneration energy to be used may be reduced.

According to an aspect of the present invention, a compound, a CO₂ absorbent including the compound, a method of preparing the CO₂ absorbent, and a method of removing CO₂ using the CO₂ absorbent may greatly decrease an amount of regeneration energy to be used by overcoming a high regeneration energy consumption and a low absorption capacity of an existing CO₂ absorbent, and increase an amount of CO₂ absorbed per unit absorbent. Thus, it is possible to decrease a size of a CO₂ absorption tower and an amount of regeneration energy to be used, whereby economical effects in terms of great reduction in costs for manufacturing an apparatus and operation expenses may be achieved.

Hereinafter, the present invention will be described in detail using examples. However, the following examples are provided only for ease of description, and are not intended to limit the scope of the present invention.

### Example 1

CO₂ absorption rate of mimetic catalyst.

Since a CO₂ absorption rate of a carbonic anhydrase is extremely fast, the CO₂ absorption rate may not be measured using a general reaction analysis system. To measure a fast reaction rate, a stopped-flow spectrometer may be used. In the present embodiment, CO₂ absorption rates of an enzyme and mimetic catalysts were measured using the SX20 stopped-flow spectrometer of Applied Photophysics. In detail, a solution saturated by injecting CO₂ into water as a solvent at predetermined temperature, for example, 25° C., was prepared. To induce reactions, a mimetic catalyst, a buffer solution, and an indicator were injected into the CO₂ saturated solution while varying amounts of the mimetic catalyst, the buffer solution, and the indicator. The reaction rates were measured by scanning an end product. Reaction rate constants of the enzyme and the mimetic catalysts were obtained based on measurement and calculation results, as shown in Table 1.

TABLE 1
Comparison of reaction rate constants of a
carbonic anhydrase and mimetic catalysts.

| Enzyme and | k_{cat}/Kₘ | |
|---|---|---|
| catalysts | [M⁻¹s⁻¹] | Remark |
| LLNL(US) - M1 | 5 × 10³ | Inorganic Chemistry, 51, 6803-6812 |
| | | (2012) |
| RMIT Univ. (AU) | 3.3 × 10³ | GHGT-9 (2008) |
| Carbonic anhydrase | 1.5 × 10⁸ | Chemical Review 108, 946-1051 |
| (HCA II) | | (2008) |
| Mimetic catalyst of | 2.68 × 10⁶ | |
| present invention | | |

As listed in Table 1, the mimetic catalyst of the present invention has a lower reaction rate constant than the carbonic anhydrase, contained in a human body, having a fastest CO₂ absorption rate. However, the mimetic catalyst of the present invention exhibits a reaction rate about 1,000 times faster than those of the existing mimetic catalysts. The natural carbonic anhydrase is extracted or replicated for use. However, due to a complex process and a high price, capturing CO₂ emitted from a stationary source may be difficult. In a case of the mimetic catalyst prepared using the chemical method as described herein, a quantity thereof may increase limitlessly and usage thereof may not be restricted. Thus, the mimetic catalyst of the present invention may be utilized as a useful CO₂ absorbent.

### Example 2

Reduction in amount of regeneration energy to be used using mimetic catalyst.

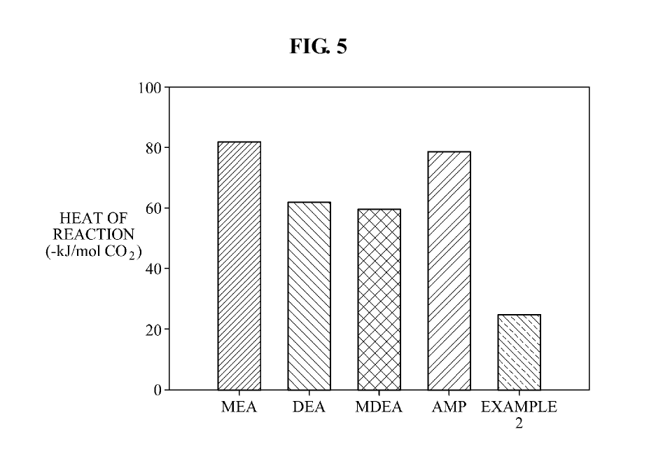

Regeneration energy of a CO₂ absorbent may be expressed based on a sum of 1 a heat of reaction of the absorbent and CO₂, 2 a sensible heat produced due to a difference in temperature between an absorption tower and a regeneration tower, and 3 an evaporative latent heat produced when water included in the absorbent evaporates. The heat of reaction of the absorbent and CO₂ indicates that CO₂ is combined with the absorbent. FIG. 5 is a graph illustrating a comparison of a CO₂ absorption capacity of a CO₂ absorbent according to an embodiment of the present invention to that of a CO₂ absorbent according to a related art. Referring to FIG. 5, in the case of amine absorbents, CO₂ absorbed energies were measured at 82.38 kilojoules per mole carbon dioxide (kJ/mol CO₂) for monoethanolamine (MEA), 70.42 kJ/mol CO₂ for diethanolamine (DEA), 59.8 kJ/mol CO₂ for methyl diethanolamine (MDEA), and 79.82 kJ/mol CO₂ for 2-amino-2-methyl-1-propanol (AMP). However, since the CO₂ absorbent of the present invention is not in a state in which CO₂ is combined with a mimetic catalyst, the CO₂ absorbed energy of the CO₂ absorbent of the present invention was measured at 24.5 kJ/mol CO₂, which is relatively low. In addition, since the regeneration was performed at 80° C., a difference in sensible heat was merely 40° C. and an evaporative latent heat of water was unnecessary. Accordingly, the CO₂ absorbent of the present invention has a lower regeneration energy consumption than the existing chemical absorbents.

When the CO₂ absorbent of the present invention is applied to a CO₂ absorbent process to separate CO₂ in combustion exhaust gas at low costs in the future, a significant contribution to guarantee greenhouse gas reduction technology against global warming may be expected. Although a concentration of CO₂ included in exhaust gas emitted at a coal-fired power plant is used as a basis, it may be applied to various CO₂ concentration ranges. Thus, the present invention may be applied equally to CO₂ absorbents to be used in homes, offices, traffic facilities, and sources emitting a large amount of CO₂ with regard to, for example, a petrochemical process, a cement industry process, and an iron preparation process.

According to exemplary embodiments of the present invention, it is possible to provide a compound, a CO₂ absorbent including the compound, a method of preparing the CO₂ absorbent, and a method of removing CO₂ that may quickly absorb CO₂ and be free from an effect of temperature and pH, thereby reducing costs for manufacturing an apparatus through reduction in a size of a CO₂ absorption tower, and may have a great area of optimized operation conditions, thereby enabling easy operation. As compared with an existing absorption-regeneration process requiring a great amount of regeneration heat since an absorbent absorbing CO₂ is transferred to a regeneration tower to separate CO₂ from the absorbent, water and bicarbonate may be produced as end products converted from CO₂ and thus, an amount of energy to be used for a regeneration reaction process may be reduced greatly, whereby a great economical effect may be achieved.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A compound comprising:
an activated metal; and
a ligand.

2. The compound of claim 1, wherein the activated metal comprises zinc.

3. The compound of claim 1, wherein the ligand comprises at least one selected from the group consisting of Tris(hydroxyl-1-benzimidazolylmethyl)amine, Tris(nitro-2-benzimidazolylmethyl)amine, 2,2-(methoxy(6-methoxypyridin-2-yl)methylene)dipyridine, and Tris(2-(6-methoxy)pyridyl)methanol.

4. The compound of claim 1, wherein the compound is represented by Formula 1, 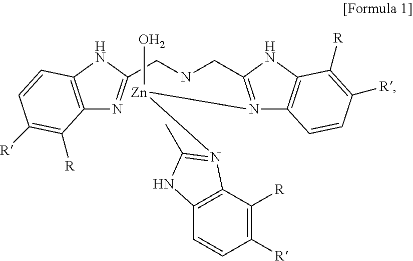
wherein R and R′ are independently selected from the group consisting of hydrogen (H), hydroxide (OH), nitrogen dioxide (NO₂), and sulphonic acid (SO₃H).

5. The compound of claim 1, wherein the compound is represented by Formula 2,

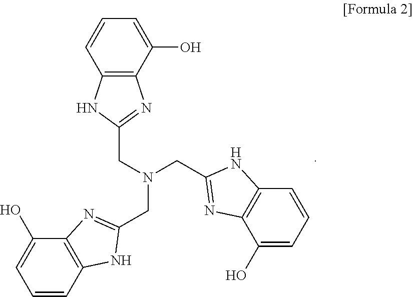 [SMILES: Oc1cccc2[nH]c(CN(Cc3nc4c(O)cccc4[nH]3)Cc3nc4c(O)cccc4[nH]3)nc12]

6. The compound of claim 1, wherein the compound is represented by Formula 3,

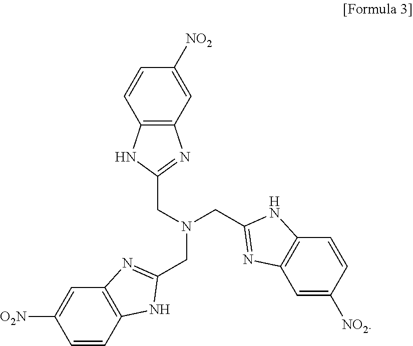 [SMILES: O=[N+]([O-])c1ccc2[nH]c(CN(Cc3nc4cc([N+](=O)[O-])ccc4[nH]3)Cc3nc4cc([N+](=O)[O-])ccc4[nH]3)nc2c1]

7. The compound of claim 1, wherein the compound is represented by Formula 4,

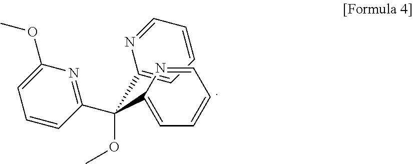

8. The compound of claim 1, wherein the compound is represented by Formula 5,

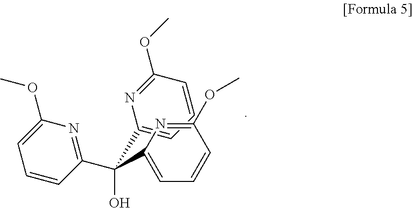

9. The compound of claim 1, wherein the activated metal ranges from 10 weight % (wt %) to 35 wt % of the compound, and
the ligand ranges from 65 wt % to 90 wt % of the compound.

10. A carbon dioxide (CO₂) absorbent comprising the compound of claim 1.

11. A method of preparing a carbon dioxide (CO₂) absorbent, the method comprising:
preparing a compound comprising an activated metal and a ligand.

12. The method of claim 11, wherein the activated metal comprises zinc.

13. The method of claim 11, wherein the ligand comprises at least one selected from the group consisting of Tris(hydroxyl-1-benzimidazolylmethyl)amine, Tris(nitro-2-benzimidazolylmethyl)amine, 2,2-(methoxy(6-methoxypyridin-2-yl)methylene)dipyridine, and Tris(2-(6-methoxy)pyridyl)methanol.

14. The method of claim 11, wherein the activated metal ranges from 10 weight % (wt %) to 35 wt % of the compound, and
the ligand ranges from 65 wt % to 90 wt % of the compound.

15. A method of removing carbon dioxide (CO₂), the method comprising:
contacting gas containing CO₂ with a CO₂ absorbent comprising a compound comprising an activated metal and a ligand;
absorbing CO₂ from the gas; and
regenerating the CO₂ absorbent.

16. The method of claim 15, wherein the absorbing is performed in the pressure range between atmospheric pressure and 10 atmospheres (atm) and the temperature range between room temperature and 70° C.

17. The method of claim 15, wherein the regenerating is performed in the pressure range between 0.01 and 5 atm and the temperature range between 80° C. and 150° C.

18. The method of claim 15, wherein the compound comprising the activated metal and the ligand is dissolved in water or a CO₂ absorbent, or comprises nanoparticles.

19. The method of claim 15, wherein the compound comprising the activated metal and the ligand circulates.

20. The method of claim 15, wherein the CO₂ absorbent further comprises at least one selected from the group consisting of a tertiary amine, potassium carbonate (K₂CO₃), lithium carbonate (Li₂CO₃), sodium carbonate (Na₂CO₃), and rubidium carbonate (Rb₂CO₃).
